(19) United States
(12) Patent Application Publication
(10) Pub. No.: US 2023/0222566 A1
(43) Pub. Date: Jul. 13, 2023

(54) ITEM RESOLUTION SERVICE

(71) Applicant: Amazon Technologies, Inc., Seattle, WA (US)

(72) Inventors: John Herd, Seattle, WA (US); Angela Minh-Chau Nguyen, Seattle, WA (US); Jackie Goldberg, Tarzana, CA (US); Timothy Heithaus, Issaquah, WA (US); Rajiv Mehta, Bellevue, WA (US)

(21) Appl. No.: 18/183,065

(22) Filed: Mar. 13, 2023

Related U.S. Application Data
(63) Continuation of application No. 16/366,940, filed on Mar. 27, 2019.

(51) Int. Cl. G06Q 30/0601

(52) U.S. Cl. CPC G06Q 30/0635; G06Q 30/0643; G06Q 30/0619

(57) ABSTRACT

Systems and methods are described for providing an item resolution service. Users may add entries to an electronic list (e.g., a grocery list), via voice input, text message, or other input to a mobile, desktop, or web application. The list entries may contain general descriptions (e.g., “milk,” “eggs,” “bread,” etc.) that can be associated with various items available from various suppliers. The item resolution service may determine, for individual list entries, a specific item based on factors such as the user who created the entry, the order or browsing history of that user, the geographic location of another user (e.g., a user who is currently located at a particular grocery store), or other factors. The list entries may thus be converted to items in an electronic shopping cart, which may then be ordered for delivery, in-store pickup, or presented in a manner that facilitates acquiring the items in person.

### CROSS-REFERENCE TO RELATED APPLICATIONS

This application is a Continuation Application of U.S. application Ser. No. 16/366,940, filed Mar. 27, 2019, which is hereby incorporated by reference in its entirety. Any and all applications for which a foreign or a domestic priority is claimed is/are identified in the Application Data Sheet filed herewith and is/are hereby incorporated by reference in their entireties under 37 C.F.R. § 1.57.

### BACKGROUND

Generally described, computing devices and communication networks can be utilized to exchange information. In a common application, a computing device can request information from another computing device or devices via a communication network. For example, a user of a personal computing device can utilize a software application process, typically referred to as an “app” or a “browser,” to request information via the Internet regarding goods or services that are offered by third parties and made available through a server computing device or devices. In such embodiments, the personal computing device can be referred to as a client computing device or a mobile computing device.

Mobile computing devices may therefore obtain and provide relevant information regarding goods and/or services (collectively and individually referred to as “items”) that are made available by multiple third parties, either by obtaining information from various third-party sites or by obtaining information from a centralized server (referred to as a “network site”) that aggregates third-party information. Mobile computing devices may further store information regarding items that a user intends to acquire.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIGS. 1A-1E are pictorial diagrams depicting illustrative user interfaces for resolving items from list entries in accordance with aspects of the present disclosure.

FIG. 2 is a block diagram depicting an illustrative network environment and a general architecture of an example computing device for implementing aspects of the present disclosure.

FIG. 3 is a flow diagram depicting an illustrative item resolution routine that may be implemented by an item resolution service in accordance with aspects of the present disclosure.

### DETAILED DESCRIPTION

Generally described, aspects of the present disclosure are directed to systems, methods, and computer-readable media related to implementing an item resolution service and resolving ambiguous user input. As used herein, the term “item,” in addition to having its ordinary meaning, is used interchangeably to refer to an item itself (e.g., a particular product or service) and to its description or representation in a computer system or electronic catalog. As will be apparent from the context in which it is used, the term is also sometimes used herein to refer only to the item itself or only to its representation in the computer system.

Items may be associated with a provider or providers. For example, a grocery store may make items available for purchase. Some items may be available from multiple providers (e.g., a particular brand and size of breakfast cereal), while other items may be available from a particular provider (e.g., a “store brand” product). Providers may generally make thousands of items available for purchase, and a user or users who wish to purchase items may make a list of items to be purchased.

In an example embodiment, a computing device may receive user input that indicates an entry should be added to such a list. The user input may be, for example, a voice command processed by a “smart speaker,” mobile computing device, or other device that implements virtual assistant technologies; text input to an application executing on the web or a mobile device; a text message received by the computing device; or other user input. The user input may provide a keyword or keyphrase to identify the item to be purchased. However, the keyword or keyphrase is typically ambiguous, and does not identify a specific item. For example, the user may provide input that includes the keyword “milk,” but a grocery store will typically stock multiple items that correspond to this keyword. The user-generated grocery list may also be input using a device that does not easily support interactive disambiguation. For example, a smart speaker may not reasonably interrogate the user to disambiguate the verbal command “remind me to buy milk” and identify a particular item.

To overcome these difficulties, an item resolution service may be implemented by, e.g., a provider of “virtual assistant” services, a developer of mobile applications, or other parties. An item resolution service, in some embodiments, may disambiguate a keyword or list entry and determine the particular item that should be associated with it. The item resolution service may thus facilitate conversion of a generic and ambiguous “grocery list” into an order that can be fulfilled by, e.g., a delivery service or curbside pickup service, or that can be used to facilitate in-store purchase of items.

It will be understood that the item resolution service described herein improves the performance of a computer at the task of resolving ambiguous user input, and thereby provides an improvement to a computer-related technology. The item resolution service reduces the amount of computing resources that are required to process ambiguous user input and identify a corresponding item or items. For example, the present disclosure includes improved user interfaces and search techniques that allow a user to more quickly access the items that are relevant to the provided input, and thereby saves the user from, e.g., having to repeatedly switch back and forth between an “electronic grocery list” application or interface and an “electronic shopping cart” application or interface. These performance improvements are especially relevant in the context of computing devices that have limited capability for interactive communication with users, such as a device that includes hardware and/or software for receiving audio input, processing the audio input to recognize speech, processing the speech to identify voice commands, carrying out the identified voice commands, and providing audio output. Such a device may be referred to herein as a “smart speaker” or assistive device. Such devices may have little or no ability to provide visual output, or may provide visual output only under certain circumstances (e.g., a device may suppress visual output if the user is driving a vehicle, or may provide visual output only if the user indicates that visual output is preferred). It will further be understood that the item resolution service addresses a problem that arises specifically in the realm of computer networks, where voice commands from multiple users may be received and processed by networked devices and disambiguated by an item resolution service.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments of the present disclosure may include several novel features, no single one of which is solely responsible for its desirable attributes or which is essential to practicing the embodiments herein described.

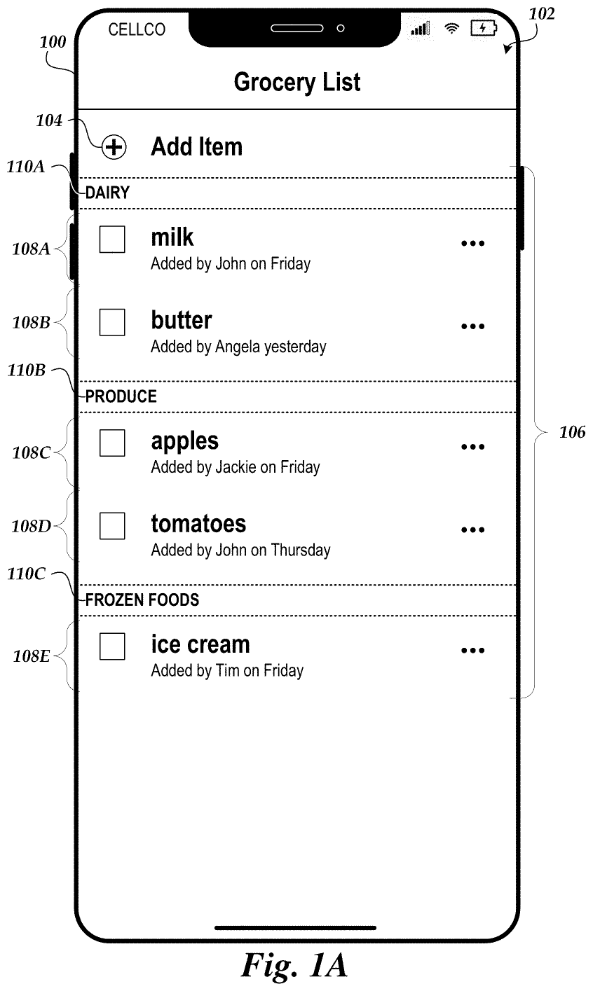

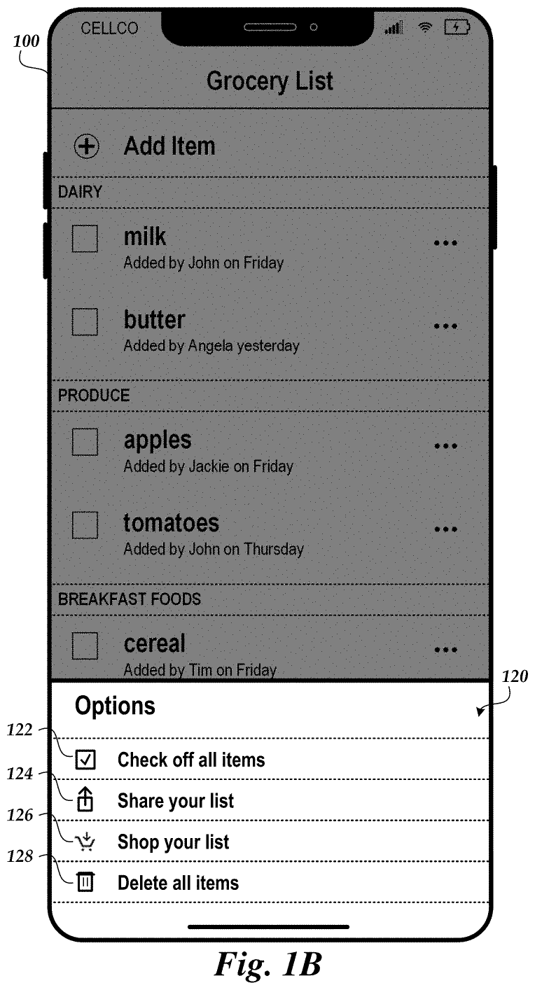

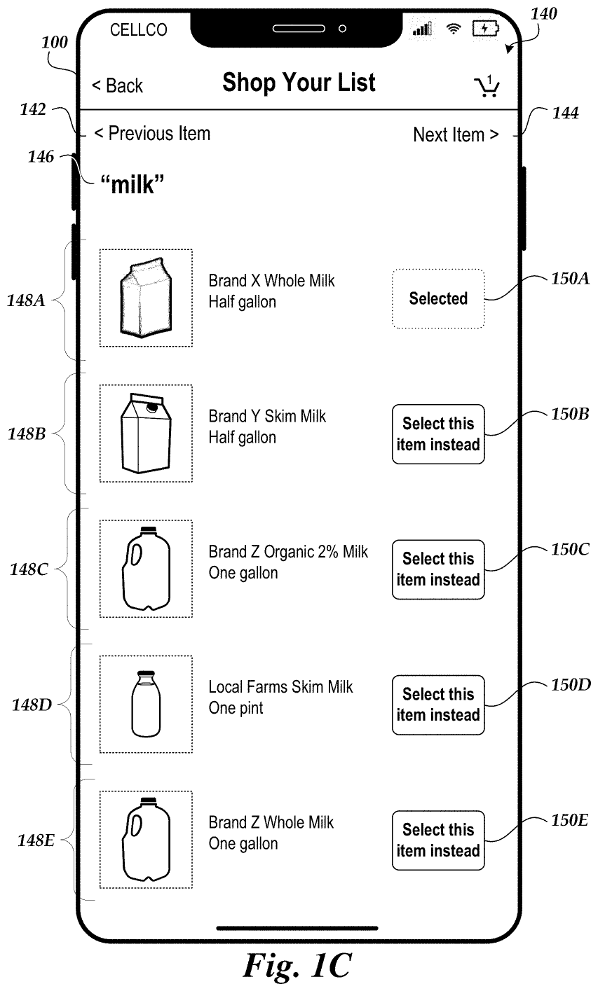

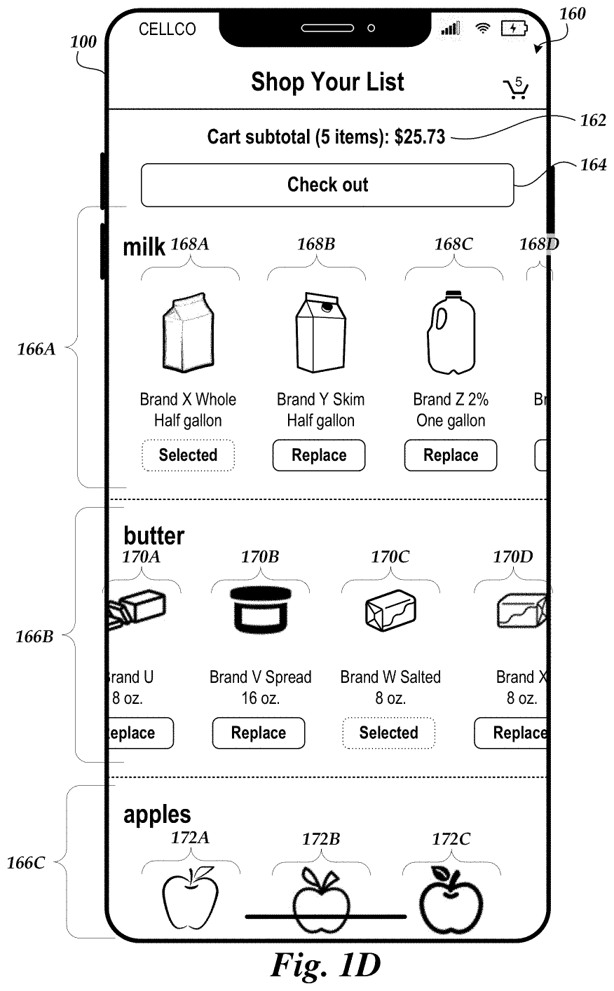

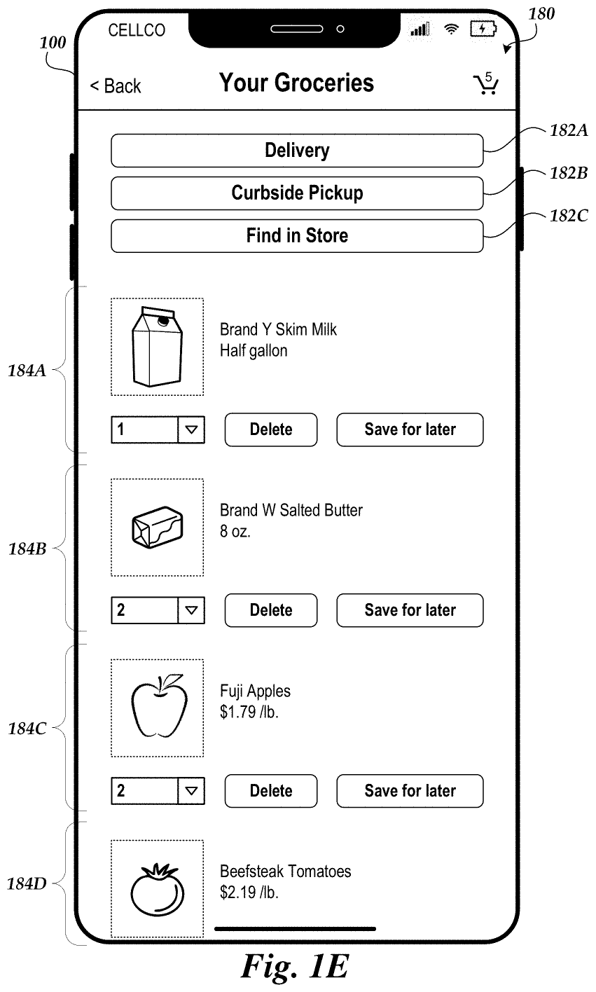

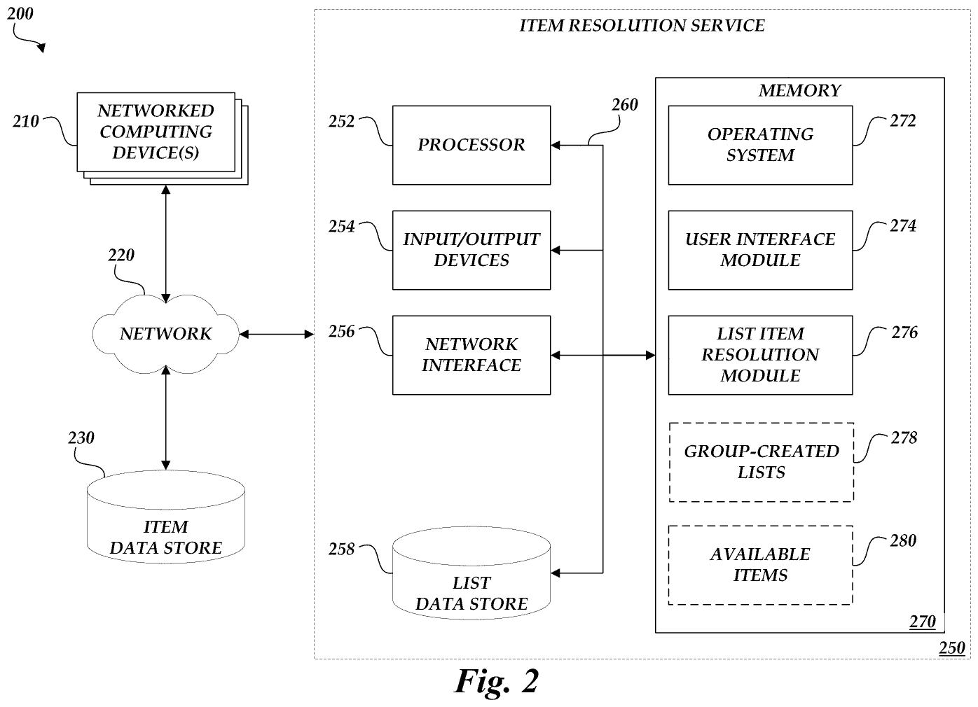

FIG. 1A is a pictorial diagram of an illustrative mobile computing device 100, which displays an illustrative grocery list user interface 102 in accordance with aspects of the present disclosure. The mobile computing device 100 is described in more detail with reference to FIG. 2 below. The illustrative grocery list user interface 102 may include an add control 104, which may be selected to add an entry or entries to a list 106. The illustrated list 106 includes entries 108A-E, each of which includes a keyword or keyphrase (e.g., “milk,” “butter,” “ice cream,” etc.) and metadata indicating when and by whom the entry was created. In some embodiments, all of the entries on the list 106 may be created by a single user. In other embodiments, including the illustrated embodiment, the list 106 may be a shared list that can be accessed and modified by several people. For example, the list 106 may be shared among family members, roommates, coworkers, or other groups, and may allow members of these groups to generate a combined list. In some embodiments, a single member of the group may be responsible for obtaining items corresponding to all of the entries on the list 106, including entries made by other group members.

The entries 108A-E on the list 106 are ambiguous in that they correspond to many items that a supplier may make available for purchase rather than to a particular item. For example, the keyphrase “ice cream” may correspond to dozens or hundreds of items that are typically stocked on the shelves of a grocery store. Similarly, the keyword “apples” may refer to one of several varieties of apple (e.g., Fuji, Gala, Granny Smith, etc.), and different users may use the keyword “butter” to refer to both dairy and non-dairy items (e.g., margarines and other spreads) of varying sizes and brands. As will be described in more detail below, an item resolution service may disambiguate these entries and associate them with specific items.

In some embodiments, the user interface 102 may include list subheadings 110A-C, which may segment the list 106 into different categories. For example, the list subheadings 110A-C may group entries together based on where the items corresponding to the keywords would be found in a grocery store (e.g., the produce aisle). In other embodiments, the list subheadings 110A-C may group entries together based on other criteria, such as entries that are associated with a particular supplier (e.g., a specific grocery store) or entries that were added by particular users.

FIG. 1B is a pictorial diagram of the mobile computing device 100 displaying a second user interface 120, which illustratively includes options 122, 124, 126, and 128 that are selectable to edit, share, or disambiguate the entries in the list 106. The second user interface 120 may illustratively be displayed by selecting a user interface control in the first user interface 102, by swiping from an edge of the display, or by other gestures or inputs. In the illustrated embodiment, the displayed options include an option 122 to check the box for all entries on the list 106, an option 124 to share the list 106 with another user, an option 126 to disambiguate the entries on the list using an item resolution service, and an option 128 to delete all entries.

In some embodiments, the user interface 102 or the user interface 120 may include controls that allow list entries 108A-E to be disambiguated individually. For example, the ellipses displayed for each of the list entries 108A-E may be selectable, and selection may cause display of a user interface (such as the user interface 140 depicted in FIG. 1C) for disambiguating the entry in question. In other embodiments, the list entry 108A-E may be disambiguated at the time it is added to the list 106, or when other conditions or criteria are met. For example, the list entries 108A-E may be disambiguated to items available in a particular grocery store if the geolocation of the mobile device 100 is determined to correspond to the grocery store. As a further example, the list entries 108A-E may be disambiguated when the list is shared with another user.

FIG. 1C is a pictorial diagram of the mobile computing device 100 displaying a third user interface 140, which illustratively displays the results of disambiguating the “milk” entry 108A depicted in FIG. 1A. As described in more detail below, an item resolution service may disambiguate an entry based on the keyword(s) and metadata associated with the entry. For example, the item resolution service may identify a set of items that correspond to the “milk” keyword, and then identify a particular item (e.g., item 148A) based on the metadata. The metadata may include, for example, information that can be used to identify a particular user and to obtain an order history, browser history, user preferences, or other information regarding that user. In some embodiments, the metadata may include geolocation data identifying a location associated with the entry or with the disambiguation of the entry. For example, an entry made for “coffee” while at a work location may disambiguate to a different item than an entry using the same keyword while at a home location. As a further example, the keyword “cereal” may disambiguate to a first item if the user is located in or near a first grocery store, and may disambiguate to a second item if the user is located in or near a second grocery store.

The illustrated user interface 140 includes previous item 142 and next item 144 controls, which allow the user to disambiguate (or view the results of disambiguating) items in the order they appeared on the list, or in some embodiments a different order. The user interface 140 further displays the keyword(s) 146 that are being disambiguated.

The user interface 140 further includes items 148A-E. In the illustrated example, the item resolution service has determined that the “milk” keyword and the associated metadata correspond to the item 148A (“Brand X whole milk, half gallon”), and displays that item 148A as a default selection when converting the list from ambiguous entries to specific items. The grayed out selector 150A indicates that the item 148A is selected. Selectors 150B-E allow the user to correct or change the determined item by selecting one of the other items 148B-E. In some embodiments, the items 148A-E are listed in a descending order, with item 148A being the most likely item that the user would like to purchase, item 148B being the next most likely item, and so forth. In other embodiments, the items 148B-E may be listed according to criteria such as popularity, availability, cost, or other factors. In still further embodiments, the items 148B-E may be sponsored items or items for which an incentive (e.g., a coupon or other promotion) is available. Additionally, in some embodiments, information or controls may be provided that allow a user to assess why a particular item, such as item 148A, was disambiguated for the keyword “milk.” For example, a “why was this item selected?” link may be displayed close to or in place of the selector 150A, and selecting the link may display information indicating that the item 148A was selected based on a purchase history of the user.

FIG. 1D is a pictorial diagram of the mobile computing device 100 displaying a fourth user interface 160, which illustratively displays the results from disambiguating multiple entries from the list depicted in FIG. 1A, and which allows a user to view and modify these disambiguations from within a single interface. In some embodiments, the user interface 160 may be presented in addition to, or as an alternative to, the user interface 140. As illustrated, the user interface 160 includes a cart subtotal 162, which allows a user to see the total cost associated with purchasing the disambiguated items. In some embodiments, the user interface 160 may include controls that allow the user to specify a budget (e.g., a cost not to exceed) for some or all of the entries 108A-E on the shopping list, and may display indications of whether or which items 168A-D, 170A-D, and 172A-C are within the specified budget. For example, the user interface 160 may highlight a set of items that total to less than a specified amount and that are likely to be items the user would like to purchase based on disambiguations of the list entries.

The user interface 160 further includes a “check out” button 164, which allows the user to indicate they are satisfied with the presented disambiguations and take further action to finalize the order. In some embodiments, selecting the button 164 may cause display of another user interface, such as the user interface 180 depicted in FIG. 1E.

The user interface 160 further includes disambiguation controls 166A-C, each of which includes a horizontally scrolling list of items (items 168A-D, 170A-D, and 171A-C respectively) that have been identified as candidate disambiguations for a particular list entry (e.g., list entries 108A, 108B, and 108C as depicted in FIG. 1A). For example, the disambiguation control 166A is depicted as displaying items 168A-D, which have been identified as corresponding to the keyword “milk” (and potentially being the item that a user intended when adding “milk” to the shopping list). The disambiguation control 166A further includes text descriptions and selectors that allow a user to modify the determined disambiguation (which is that item 168A corresponds to the “milk” list entry 108A). It will be understood that the horizontally scrolling list may include more items than those depicted in FIG. 1D, and that the other items may be scrolled into view by, e.g., swiping left or right on the disambiguation control 166A.

Disambiguation control 166B similarly displays items 170A-D, which may correspond to the keyword “butter.” In the illustrated embodiment, the user has swiped on the disambiguation control 166B to bring additional items (e.g., item 170D) into view, and has selected item 170C as the item that corresponds to the “butter” keyword (overriding the default disambiguation to item 170A). In some embodiments, as described in more detail below, an item resolution service may apply weighting factors or other adjustments to its disambiguation routine based on user selections of items via the user interface 160. Disambiguation control 166C similarly displays items 172A-C. In some embodiments, the user interface 160 may be scrolled vertically to bring more of disambiguation control 166C into view or to bring other disambiguation controls into view (e.g., a disambiguation control corresponding to the “tomatoes” list entry 108D or the “ice cream” list entry 108E).

In various embodiments, all or part of the user interface 160 may be presented in combination with other user interfaces. For example, the disambiguation control 166A may be displayed when the user selects the ellipsis (or another control) for list entry 108A on FIG. 1A. As a further example, the cart subtotal 162 may be displayed on any of the other user interfaces 102, 120, 140, or 180. Still further, items 168A-D, 170A-D, and/or 172A-C may be displayed as icons only, and may expand to include other information or controls if the icon is selected. Other examples beyond the illustrated embodiment are thus understood to be within the scope of the present disclosure.

FIG. 1E is a pictorial diagram of the mobile computing device 100 displaying a fifth user interface 180, in which the original list 106 has been disambiguated into specific items. The user interface 180 includes items 184A-D, which are the individual items that were determined to correspond to the entries 108A-D depicted in FIG. 1. For example, the “butter” entry 108B has been associated with item 184B (an eight-ounce package of Brand W salted butter), and the “apples” entry 108C has been associated with item 184C (Fuji apples). As described below, the item resolution service may determine the item to associate with a particular list entry 184A-D based on, for example, information in the metadata, information regarding a particular user (e.g., the user who created the entry or the user who is viewing the user interface 180), a geolocation of the mobile computing device 100, availability of the item, and other factors. The user interface 180 may include additional items beyond those depicted in FIG. 1D, which may be accessed by, e.g., scrolling.

The user interface 180 further includes options 182A-C for acquiring the items 184A-D. For example, delivery option 182A, when selected, causes a list of the items 184A-D to be provided to a delivery service for delivery to an address associated with the user. Similarly, in-store pickup option 184A, when selected, causes a list of the items 184A-D to be provided to a supplier (e.g., a grocery store) for curbside or in-store pickup. List by aisle option 182C, in some embodiments, may present the list of items in a format that facilitates acquiring the physical items directly. For example, the items may be displayed on an aisle-by-aisle basis, or may be displayed on a map of the store.

It will be understood that FIGS. 1A-1E are provided for purposes of example, and that other interfaces for receiving user input are within the scope of the present disclosure. For example, a smart speaker, wearable device, or other computing device may provide a “virtual assistant” or other interface for adding entries to a list by voice command (e.g., “add butter to the grocery list”), or for providing a keyword outside the context of a list (e.g., “remind me to buy a frozen pizza the next time I'm at the grocery store”), and may not provide visual interfaces such as those depicted in the example embodiments. It will further be understood that various interfaces containing more, fewer, or different elements than those depicted in FIGS. 1A-1E are within the scope of the present disclosure. FIGS. 1A-1E are thus understood to be illustrative and not limiting.

FIG. 2 is a block diagram depicting an illustrative network environment 200 for implementing an item resolution service 250 in accordance with aspects of the present disclosure. The illustrated network environment 200 depicts networked computing devices 210 (which may include assistive devices as described above and/or the mobile computing device 100 depicted in FIGS. 1A-1D), an item resolution service 250, and an item data store 230 communicating via a network 220.

The networked computing devices 210 may be any computing devices that implement aspects of the present disclosure, such as obtaining user-specified keywords or list entries and obtaining or generating associated metadata. In some embodiments, the networked computing devices 210 may implement all or part of the item resolution service as described herein. In other embodiments, the networked computing devices 210 may communicate with a server or other computing device that implements the item resolution service. Additionally, in some embodiments, the networked computing devices 210 may present one or more of the user interfaces depicted in FIGS. 1A-1D.

The item data store 230 may illustratively be any non-transient computer-readable medium, including but not limited to hard drives, solid state devices, flash memories, EEPROMs, or other storage media. In various embodiments, the item data store 230 may be implemented as a database, a database server, a component of another server or service (e.g., a networked computing device 210), or may be combined with the item resolution service 250 and made internal to the item resolution service 250. In yet other embodiments, a data store may include or be embodied in a data storage web service.

The network environment 200 may further include a network 220. The network 220 may illustratively be any wired or wireless network, or combination thereof. In addition, the network 220 may include, but is not limited to, a cellular telecommunications network, Wi-Fi network, cable network, satellite network, mesh network, personal area network, local area network (LAN), wide area network (WAN), public or private intranet, the Internet, or other public or private communications network or networks, or any combination thereof. In some embodiments, the network 220 may be a private or semi-private network, such as a corporate or university intranet. The network 220 may include one or more wireless networks, such as a Global System for Mobile Communications (GSM) network, a Code Division Multiple Access (CDMA) network, a Long Term Evolution (LTE) network, or some other type of wireless network. The network 220 may use protocols and components for communicating via the Internet or any of the other aforementioned types of networks. In some embodiments, the network 220 may be omitted, and one or more of the networked computing devices 210, item data store 230, or item resolution service 250 may communicate directly with each other.

The network environment 200 may further include an item resolution service 250, which includes an arrangement of computer hardware and software components that may be used to implement aspects of the present disclosure. The network environment 200 and the item resolution service 250 may include many more (or fewer) elements than those shown in FIG. 2. It is not necessary, however, that all of these elements be shown in order to provide an enabling disclosure.

As illustrated, the item resolution service 250 includes a processor 252, input/output devices 254, a network interface 256, and a data store 258, all of which may communicate with one another by way of a communication bus 260. The network interface 256 may provide connectivity to one or more networks (such as network 220) or computing systems and, as a result, may enable the item resolution service 250 to receive and send information and instructions from and to other computing systems or services, such as the networked computing devices 210. In some embodiments, the item resolution service 250 may be configured to process requests from the networked computing devices 210, such as requests to add entries to a list or disambiguate the entries in a list.

The processor 252 may also communicate to and from a memory 270. The memory 270 may contain computer program instructions (grouped as modules or components in some embodiments) that the processor 252 may execute in order to implement one or more embodiments. The memory 270 generally includes RAM, ROM, and/or other persistent, auxiliary, or non-transitory computer-readable media. The memory 270 may store an operating system 272 that provides computer program instructions for use by the processor 252 in the general administration and operation of the item resolution service 250. The memory 270 may further store specific computer-executable instructions and other information (which may be referred to herein as “modules”) for implementing aspects of the present disclosure. For example, the memory 270 may include a user interface module 274, which may perform various operations with regard to displaying the user interfaces described herein. For example, the user interface module 274 may manage all or part of the display of the user interfaces depicted in FIGS. 1A-1D and manage the processing of user input via these interfaces.

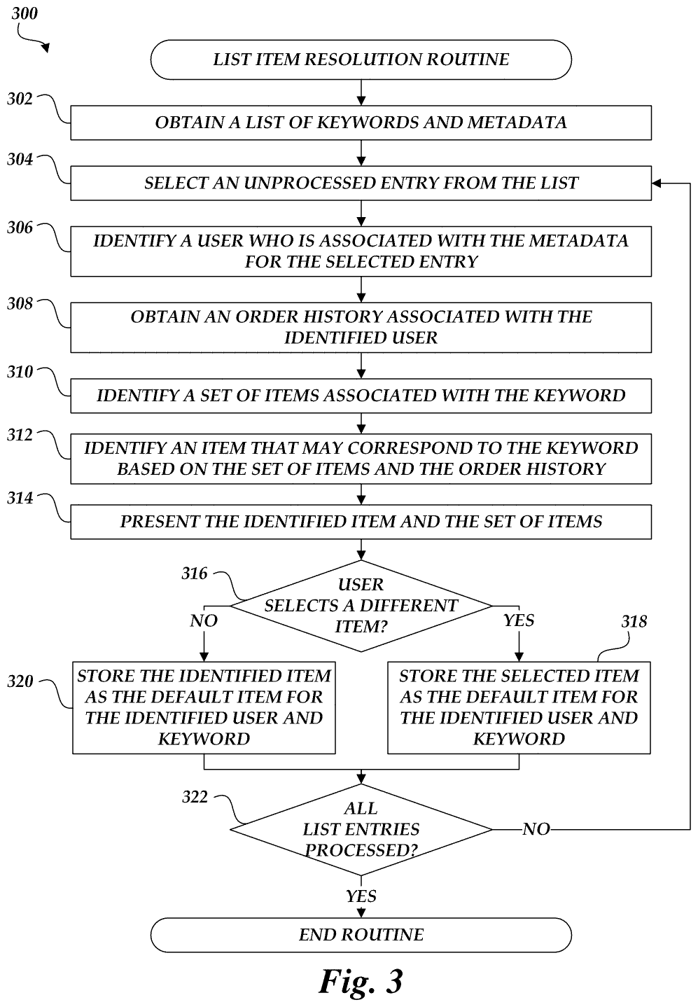

In some embodiments, the memory 270 may include a list item resolution module 426, which may be executed by the processor 252 to perform various operations, such as those operations described with reference to FIG. 3 below. The memory 270 may further include group-created lists 278 and available items 280, which may be loaded into the memory 270 as various operations are performed. In some embodiments, the available items 280 may be obtained from the item data store 230 via the network 220, and the group-created lists 278 may be obtained from the list data store 258. In other embodiments, the available items 280 may be obtained from a local data store and the group-created lists 278 may be obtained via the network 220.

While the operating system 272, user interface module 274, and list item resolution module 276 are illustrated as distinct modules in the memory 270, in some embodiments, the user interface module 274 and the list item resolution module 276 may be incorporated as modules in the operating system 272 or another application or module, and as such, separate modules may not be required to implement some embodiments. In some embodiments, the user interface module 274 and the list item resolution module 276 may be implemented as parts of a single application.

It will be recognized that many of the components described in FIG. 2 are optional and that embodiments of the item resolution service 250 may or may not combine components. Furthermore, components need not be distinct or discrete. Components may also be reorganized. For example, the item resolution service 250 may be represented in a single physical device or, alternatively, may be split into multiple physical devices. In some embodiments, components illustrated as part of the item resolution service 250 (such as the list data store 258) may additionally or alternatively be included in other computing devices, such that some aspects of the present disclosure may be performed by the item resolution service 250 while other aspects are performed by another computing device.

In some embodiments, the features and services provided by the item resolution service 250 may be implemented as web services consumable via a communication network such as a cellular network, packet data network, satellite network, or the like. In further embodiments, the item resolution service 250 may be provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

FIG. 3 is a flow diagram depicting an illustrative list item resolution routine 300. The illustrative list item resolution routine 300 may be carried out in whole or in part, for example, by the item resolution service 250 of FIG. 2, the networked computing devices 210 of FIG. 2, or both. At block 302 a list of user-created entries, each including a keyword or keyphrase and associated metadata, may be obtained. In some embodiments, a single keyword and associated metadata may be obtained rather than a list, and the routine 300 may be invoked repeatedly to process a list of entries. In various embodiments, user-created entries may be generated via the user interface 100 depicted in FIG. 1A, by issuing voice commands to an assistive device (e.g., “Alexa, add eggs to the grocery list”), or via other audio or visual interfaces.

At block 304, an entry on the list that has not yet been processed may be selected. At block 306, the metadata may be analyzed to identify a user associated with selected entry. In some embodiments, the metadata may include user identifying information, such as an account ID or other unique identifier. In other embodiments, the metadata may include information that enables user identification, such as information regarding a device that was used to make the entry, information that enables recognition of a particular user's voice, or other information that can be used to determine an associated user. In some embodiments, the user associated with the entry may not be the user who created the entry. For example, a user may create an entry on behalf of another user, or the user viewing an entry may be associated with the entry.

At block 308, an order history associated with the user identified at block 306 may be obtained. Illustratively, an order history may be used to provide context for the keyword or keyphrase associated with the entry. In some embodiments, other information, such as a browsing history, user preferences, user selections from previous executions of the routine 300, or data from other sources may be obtained in addition to or in place of an order history.

At block 310, a set of items associated with the keyword or keyphrase may be obtained from a data store, such as the item data store 230 depicted in FIG. 2. For example, a set of items associated with the keyword “milk” may include several brands, sizes, and varieties of milk, each of which is associated with a distinct identifier such as a UPC code, catalog number, URL, inventory tag, or other identifier. In some embodiments, the set of items may be obtained based on a geolocation or other information. For example, a set of items associated with a particular grocery store may be obtained based on the proximity of a mobile computing device 100 to the grocery store. As further examples, a set of items may be obtained based on a current geolocation of the mobile computing device 100, such as a “home” location or a “work” location, or based on a geolocation of the mobile computing device 100 at the time the entry containing the keyword was added to the list. Still further, in some embodiments, a set of items may be obtained based on a geographic region. For example, a set of items associated with the keyphrase “iced tea” may include sweet teas if the user is located in the American South, and may include only unsweetened teas otherwise.

In some embodiments, a data store may store items that are tagged with various keywords, and the set of items obtained at block 310 may be obtained by querying the data store for items that are tagged with the keyword or a similar term. For example, a particular item's tags may include terms such as “cereal,” “breakfast,” “oatmeal,” “instant,” “high fiber,” “apple and cinnamon,” and “Brand X.” The set of items obtained for a keyword such as “cereal” or “oatmeal” may thus include the particular item. In some embodiments, the set of items obtained at block 310 may be further narrowed based on information such as the user's order history, browser history, the relative popularity of items (generally or within a particular geographic area), the user's delivery address or pickup address, and the like. In other embodiments, a set of items may be associated with a keyword based on previous executions of the routine 300. For example, a previous execution of the routine 300 may have resulted in this user or a different user associating a particular item with a keyword. In further embodiments, the item resolution service may determine the set of items to obtain for a particular user and keyword based on the items selected by other users who created a list entry using the keyword or a similar keyword. The item resolution service may, in some embodiments, analyze a user profile, demographics, or other information to identify similar users and identify items that these users have associated with the keyword or keyphrase.

At block 312 an item may be identified that may correspond to the keyword based on the set of items obtained at block 310 in the order history obtained at block 308. Illustratively, in some embodiments, the order history may include an order of the item that is identified at block 312. In other embodiments, the order history may include a similar item or an item that can be associated with the item that is identified. For example, the keyphrase “strawberry yogurt” may be disambiguated to a particular item (e.g., a six-pack of Brand X strawberry yogurt cups) based on the user's previous purchase of a different item (e.g., Brand X vanilla yogurt). In some embodiments, the order history may be analyzed to identify patterns or trends, and an item may be identified based on these patterns. For example, the keyword “detergent” may disambiguate to an item of laundry detergent if the user's order history suggests that a recurring laundry detergent purchase is due in the near future, but may disambiguate to an item of dishwashing detergent if the order history indicates that laundry detergent was purchased recently and dishwashing detergent has not been purchased recently. As discussed above, in some embodiments, information other than an order history, such as the current geolocation of a mobile computing device 100 or the identity of the user requesting disambiguation, may be used to identify the item.

In some embodiments, an item may be identified based on other items or keywords on the same list. For example, the keyword “candles” may be disambiguated to birthday candles if the keyword “cake” is also on the list, and may be disambiguated to scented candles otherwise. In other embodiments, an item may be identified based on demographic data (e.g., birthday candles may be identified if the user or a family member has a birthday coming up), or as discussed above an order history may be analyzed to identify that birthday candles were purchased at this time last year. Additionally, in some embodiments, an item may be identified based on factors such as prices, coupons, sales, or similar factors. For example, a user's order history or preferences may indicate that the keyword “paper towels” should disambiguate to the item that matches this keyphrase and is least expensive at the time of purchase, or that “soap” should disambiguate to Brand X bar soap unless the Brand Y liquid soap is on sale.

At block 314, a user interface that includes the identified item and at least part of the set of items may be presented. Illustratively, the user interface 160 depicted in FIG. 1C may be presented. In some embodiments, the identified items may be presented along with the user interface controls that enable changing the item and displaying alternative items. As discussed above, a subset of the set of items may be selected according to a predicted likelihood that the keyword disambiguates to other items in the set. For example, the routine 300 may at block 312 assign a score to each of the items in the set of items, which may represent the likelihood that the item corresponds to the keyword and is what the user intended to purchase. The items may then be listed in descending order by score, with the highest-scoring item being the item identified at block 312. In some embodiments, the identified item may be presented as a default, and may be presented with information indicating why this item was identified. For example, the user interface may indicate that a particular item was identified because of a recent purchase of a similar item. In some embodiments, items such as sponsored items, best-selling items, new items, or items that are subject to a promotional offer may be displayed in place of or in addition to items in the set of items. Additionally, in some embodiments, the user interface presented at block 314 may be presented to a different user than the user who was identified at block 306.

At decision block 316 a determination is made as to whether the user has selected a different item than the one which was identified at block 312 if yes, then at block 318 the item that the user has selected may be stored as the default item-keyword association (associating the selected item with the obtained keyword) for that user. In some embodiments, the user selection may be stored as a weighting factor or other adjustment to the item identification carried out at block 312. For example, the set of items associated with the “ice cream” keyword may include a pint of Brand X strawberry ice cream, a quart of Brand Y vanilla ice cream, and a 12-pack of Brand Z ice cream bars. If the Brand Y item is identified at block 312, and the determination at block 316 is that the user selected the Brand Z item, then future iterations of the routine 300 may identify the Brand Z item at block 312 based on the number of times that the user has purchased that item after using the “ice cream” keyword. In some embodiments, more recent item purchases may be weighted more heavily than less recent item purchases, or may be weighted based on factors such as, e.g., the amount of time between purchases. For example, the weighting factors of items with larger sizes or quantities (e.g., a gallon of milk vs. a pint of milk) may be increased if the user typically purchases a pint of milk but has not done so recently. Weighting factors may illustratively be implemented as an increased or decreased probability that a particular item is the item that should be associated with a particular list entry. In some embodiments, weighting factors may be adjusted from a baseline value based on the criteria such as the above. In further embodiments, weighting factors may be adjusted based on criteria such as product returns, order cancellations, user reviews, and the like.

If the determination at decision block 316 is that the user has not selected a different item, then at block 320 an item-keyword association, which associates the keyword at block 302 with the item identified at block 312, is stored as the default association for this user and this keyword. In some embodiments, item-keyword associations stored by a previous execution of the routine 300 may be retrieved at block 312 and used to identify an item associated with a particular keyword. In further embodiments, items that other users have associated with the obtained keyword may be retrieved and analyzed to determine a predicted default for the identified user. For example, the routine 300 may determine at block 312 that a particular item is the most likely item to be associated with the keyphrase “orange juice” based on other users purchasing that item after using the same keyphrase. In some embodiments, demographic information may be used to further refine the set of items obtained at block 310 and the identification of an item at block 312. For example, different sets of items may be identified for the keyword “deodorant,” and a different item identified from with the set, depending on the age, gender, or other demographics of the identified user. In some embodiments, a machine learning model may be used to predict the most likely item associated with a particular keyword or keyphrase given the metadata and/or the available information regarding the user.

At decision block 322, a determination is made as to whether all of the entries in the list obtained at block 302 have been processed and disambiguated. If not, then the routine 300 branches to block 304, selects an entry that has not been disambiguated, and iterates until all of the list entries have been disambiguated. The routine 300 then ends.

In various embodiments, the blocks of the routine 300 may be combined, omitted, or carried out in various orders. For example, block 310 may be carried out prior to or in parallel with blocks 306 and 308. As a further example, block 310 may be carried out for common keywords prior to execution of the routine 300, and the resulting set of items (e.g., the items that correspond to “paper towels”) may be obtained rather than being identified as part of carrying out the routine 300. The routine 300 is thus understood to be illustrative and not limiting.

Although many of the example embodiments herein relates to groceries and shared grocery lists, it will be understood that the present disclosure is not limited to particular types or categories of items or injuries. For example, users may create a shared list of office supplies, school supplies, clothing, sporting goods, automotive goods, or other ambiguous entries, and the item resolution service may disambiguate these entries into specific items. Additionally, in some embodiments, the item resolution service may be applied to a list created by a single individual. For example, the item resolution service may be used to identify items that a particular user will go “out of their way” to purchase (e.g., “coffee” may disambiguate to a particular brand or variety of coffee that is only available at a particular store, even if the user is currently in a different store that also sells coffee) vs. entries that disambiguate to different items when the user is in different places (e.g., “bread” may disambiguate to a first item if the user is in a first grocery store that sells the first item exclusively, but disambiguate to a different item if the user is elsewhere).

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A non-transitory computer-readable medium storing computer-executable instructions that, when executed by a processor, cause the processor to:
obtain, from memory of a computing device, a list of entries, wherein the list of entries includes:
a first entry that is associated with a first user of a plurality of users, the first entry including: (i) a first keyword that corresponds to a first plurality of items available for selection rather than a first particular item available for selection, and (ii) first metadata associated with the first user, and
a second entry that is associated with a second user of the plurality of users, the second entry including: (i) a second keyword that corresponds to a second plurality of items available for selection rather than a second particular item available for selection, and (ii) second metadata associated with the second user;
disambiguate the first keyword included in the first entry of the list into the first particular item available for selection rather than the first plurality of items available for selection;
cause the first particular item and at least a portion of a set of particular items to be presented via a user interface;
receive a selection, made via the user interface, of the first particular item; and
in response to receiving the selection of the first particular item, cause the first particular item instead of the first keyword to be presented via the user interface.

2. The non-transitory computer-readable medium of claim 1, wherein to disambiguate the first keyword, the non-transitory computer-readable medium stores further computer-executable instructions that, when executed by the processor, cause the processor to:
determine, from the first metadata included in the first entry, that the first entry is associated with the first user of the plurality of users,
obtain a first history of particular items selected by the first user,
identify the set of particular items corresponding to the first keyword, and
identify, based at least in part on the first history of particular items selected by the first user, the first particular item from the set of particular items that corresponds to the first keyword.

3. The non-transitory computer-readable medium of claim 2, wherein to identify the set of particular items corresponding to the first keyword, the non-transitory computer-readable medium stores further computer-executable instructions that, when executed by the processor, cause the processor to query for particular items that are tagged with a tag related to the first keyword.

4. The non-transitory computer-readable medium of claim 2, wherein identifying the first particular item from the set of particular items is based at least in part on popularity of the first particular item, geolocation data of the first user, or a demographic of the first user.

5. The non-transitory computer-readable medium of claim 1 storing further computer-executable instructions that, when executed by the processor, cause the processor to:
generate an item-keyword association for the first user that associates the first keyword with the first particular item; and
store the item-keyword association in the memory.

6. The non-transitory computer-readable medium of claim 1, wherein the first metadata associated with the first user comprises at least one of a temporal data associated with adding the first entry to the list of entries, an identity of the first user, geolocation data associated with the first entry, or geolocation data associated with the first user.

7. The non-transitory computer-readable medium of claim 1, wherein the user interface comprises a first user interface element and a second user interface element, and wherein the non-transitory computer-readable memory stores further computer-executable instructions that, when executed by the processor, cause the processor to:
receive a selection, made via the user interface, of the first user interface element or the second user interface element;
in response to receiving the selection of the first user interface element, disambiguate: (i) the first keyword included in the first entry of the list into the first particular item available for selection rather than the first plurality of items available for selection, and (ii) the second keyword included in the second entry of the list into the second particular item available for selection rather than the second plurality of items available for selection; and
in response to receiving the selection of the second user interface element, disambiguate the first keyword included in the first entry of the list into the first particular item available for selection rather than the first plurality of items available for selection instead of disambiguating the second keyword included in the second entry of the list into the second particular item available for selection rather than the second plurality of items available for selection.

8. A computer-implemented method comprising:
obtaining, from memory of a computing system, a list of entries, wherein the list of entries includes:
a first entry added to the list by a first user of a plurality of users via a first computing device, the first entry including: (i) a first keyword that corresponds to a first plurality of items available for selection rather than a first particular item available for selection, and (ii) first metadata associated with adding the first entry to the list via the first computing device, and
a second entry added to the list by a second user of the plurality of users via a second computing device, the second entry including: (i) a second keyword that corresponds to a second plurality of items available for selection rather than a second particular item available for selection, and (ii) second metadata associated with adding the second entry to the list via the second computing device;
causing the list of entries to be presented via a user interface;
receiving a first selection, made via the user interface, of the first entry from the list of entries presented;
disambiguating the first keyword included in the first entry of the list into the first particular item available for selection rather than the first plurality of items available for selection, wherein disambiguating the first keyword comprises:
determining, from the first metadata included in the first entry, that the first user of the plurality of users added the first entry to the list of entries,
obtaining a first history of particular items selected by the first user,
identifying a set of particular items corresponding to the first keyword,
identifying, based at least in part on the first history of particular items selected by the first user, a first particular item from the set of particular items that corresponds to the first keyword;
causing the first particular item and at least a portion of the set of particular items to be presented via the user interface;
receiving a second selection, made via the user interface, of at least one of the first particular item or another particular item from the set of particular items; and
in response to receiving the second selection, replacing, in the list of entries stored in the memory, the first keyword included in the first entry with a first particular keyword corresponding to the at least one of the first particular item or another particular item that is selected.

9. The computer-implemented method of claim 8, wherein the second selection is of the first particular item of the set of particular items, and wherein the computer-implemented method further comprises:
generating an item-keyword association for the first user that associates the first keyword with the first particular item; and
storing the item-keyword association in the memory.

10. The computer-implemented method of claim 9, further comprising:
causing another list of entries to be presented, wherein the other list of entries includes a third entry added to the other list by the first user, and wherein the third entry includes the first keyword that corresponds to the first plurality of items available for selection rather than the first particular item available for selection; and
disambiguating the first keyword into the first particular item based at least in part on the item-keyword association.

11. The computer-implemented method of claim 8, wherein identifying the set of particular items corresponding to the first keyword comprises querying for particular items that are tagged with a tag related to the first keyword.

12. The computer-implemented method of claim 8, wherein identifying the first particular item from the set of particular items is based at least in part on popularity of the first particular item, geolocation data of the first user, or a demographic of the first user.

13. The computer-implemented method of claim 8, wherein the first history of particular items selected by the first user includes the first particular item.

14. The computer-implemented method of claim 8, wherein identifying the first particular item from the set of particular items is based at least in part on a number of times the first user has selected the first particular item.

15. The computer-implemented method of claim 8, wherein the first metadata associated with the first user comprises at least one of a temporal data associated with adding the first entry to the list of entries, an identity of the first user who added the first entry to the list of entries, geolocation data associated with the first entry, or geolocation data associated with the first user.

16. A computing device comprising:
a display;
a memory configured to store specific computer-executable instructions;
a processor in communication with the memory and the display, wherein the processor is configured to execute the specific computer-executable instructions to at least:
present, via the display, a user interface including a list of entries, wherein the list of entries includes a first entry added to the list of entries by a first user of a plurality of users, and wherein the first entry comprises a first keyword that corresponds to a first plurality of items available for selection rather than a first particular item available for selection;
receive a selection of the first entry from the list of entries included in the user interface;
obtain a first disambiguation of the first keyword of the first entry and a second disambiguation of the first keyword of the first entry, wherein:
the first disambiguation of the first keyword of the first entry corresponds to the first particular item available for selection rather than the first plurality of items available for selection,
the second disambiguation of the first keyword of the first entry corresponds to a second particular item available for selection rather than the first plurality of items available for selection, and
the first disambiguation of the first keyword of the first entry and the second disambiguation of the first keyword of the first entry are determined from the first keyword, first metadata associated with the first user adding the first entry to the list of entries, and a first history of particular items selected by the first user;
update the user interface presented via the display to include the first disambiguation of the first keyword of the first entry and the second disambiguation of the first keyword of the first entry;
receive a selection of the first disambiguation of the first keyword of the first entry; and
update the user interface presented via the display to include the list of entries with the first entry comprising the first disambiguation of the first keyword instead of the first keyword.

17. The computing device of claim 16, wherein the list of entries included in the user interface presented via the display includes a second entry added to the list by a second user of the plurality of users via a second computing device, the second entry comprising a second keyword that corresponds to a second plurality of items available for selection rather than a third particular item available for selection, and wherein the processor is configured to execute further specific computer-executable instructions to at least:
receive a selection of the second entry from the list of entries included in the user interface; and
obtain a first disambiguation of the second keyword of the second entry, wherein:
the first disambiguation of the second keyword of the second entry corresponds to the third particular item for selection rather than the second plurality of items available for selection, and
the first disambiguation of the second keyword of the second entry is determined from the second keyword, second metadata associated with the second user adding the second entry to the list of entries, and a second history of particular items selected by the second user.

18. The computing device of claim 17, wherein the processor is configured to execute further specific computer-executable instructions to at least update the user interface presented via the display to include the list of entries with the first entry comprising the first disambiguation of the first keyword instead of the first keyword and with the second entry comprising the first disambiguation of the second entry instead of the second keyword.

19. The computing device of claim 16, wherein the first disambiguation of the first keyword of the first entry and the second disambiguation of the first keyword of the first entry are determined from the first keyword, the first metadata associated with the first user adding the first entry to the list of entries, and a first history of particular items selected by the first user, by:
determining from the first metadata that the first user of the plurality of users added the first entry to the list of entries,
obtaining the first history of particular items selected by the first user determined from the first metadata,
identifying a set of particular items corresponding to the first keyword of the first entry,
identifying, based at least in part on the first history of particular items selected by the first user, a first particular item from the set of particular items that corresponds to the first keyword of the first entry and a second particular item from the set of particular items that corresponds to the first keyword of the first entry,
using the first particular item as the first disambiguation of the first keyword of the first entry, and
using the second particular item as the second disambiguation of the first keyword of the first entry.

20. The computing device of claim 19, wherein:
the processor is configured to execute further computer-executable instructions to at least determine that a geolocation of the computing device corresponds to a first item provider, and wherein:
the first particular item is identified from the set of particular items based at least in part on the first history of particular items selected by the first user and an availability of the first particular item from the first item provider.
